(19) United States
(12) Patent Application Publication
(10) Pub. No.: US 2006/0287901 A1
(43) Pub. Date: Dec. 21, 2006

(54) ELECTRONIC KNOWLEDGE RESOURCES: USERS' MOMENTARY ASSESSMENT OF THE COGNITIVE-BEHAVIORAL IMPACT OF INFORMATION HITS

(75) Inventors: Roland Grad, Dollard-des-Ormeaux, QC (CA); Pierre Pluye, Montreal, QC (CA); Yuejing Meng, Anjou, QC (CA)

Correspondence Address: BERESKIN AND PARR, 40 KING STREET WEST, BOX 401, TORONTO, ON, M5H 3Y2, CA

(73) Assignee: McGill University, Montreal (CA)

(21) Appl. No.: 11/424,473

(22) Filed: Jun. 15, 2006

Related U.S. Application Data
(60) Provisional application No. 60/690,510, filed on Jun. 15, 2005.

(51) Int. Cl. G06F 9/44

(52) U.S. Cl. 705/7

(57) ABSTRACT

Users to self-report in real-time an assessment of the cognitive-behavioral impact of the information provided by electronic information resources, whatever their type (e.g. CMC, DSS or IRT) or platform (e.g. desktop, internet, handheld computer or laptop). A computerized real-world momentary assessment method is combined with a 5-level impact assessment scale. For the maintenance and comparison of resources, assessment of impact is complementary to existing relevance-based evaluation (e.g. user satisfaction).

### CROSS-REFERENCE TO RELATED APPLICATION

This patent application claims priority on U.S. provisional application No. 60/690,510 entitled “ELECTRONIC KNOWLEDGE RESOURCES: USERS MOMENTARY ASSESSMENT OF THE COGNITIVE-BEHAVIORAL IMPACT OF INFORMATION HITS” and filed on Jun. 15, 2005.

### FIELD OF THE INVENTION

The present invention relates to the field of electronic information resources, whatever their type (e.g. Computer Mediated Communication, Decision Support Systems or Information Retrieval Technology) or platform (e.g. desktop, internet, handheld computer or laptop).

### BACKGROUND OF THE INVENTION

Electronic information resources are widely used, and have improved access to information (e.g. biomedical databases). Three terms to describe these resources are Computer Mediated Communication (CMC), Decision Support Systems (DSS) and Information Retrieval Technology (IRT). These terms respectively correspond to three types of social action: communication (CMC), programmed decision making (DSS) and non-programmed decision making (IRT). Information is defined as explicit knowledge with a physical form and units (e.g. web pages), namely information hits (Grad et al. 2005) or chunks (Taylor 1986). For example, Grad et al (2005) used a built-in function to record data on information-seeking behavior derived from the user's tap pattern, tracking all information accessed by doctors in a log file on their hand-held computer. Log files provided specific characteristics on the item of information viewed by the doctor, such as item title, unique ID number and when the item of information was opened (date and time stamp). These characteristics defined an information hit, with the impact of each hit ascertained by the present invention.

Firstly, communication is defined as a mutual understanding of messages. In line with Thurlow et al. (2004), CMC “refers to any human communication achieved through, or with the help of, computers”, and corresponds to a network of people within organizations (email, mailing lists, newsgroups, bulletin boards, blogs and chat-rooms). CMC is increasingly multimodal by combining verbal and non-verbal messages (text, images, sounds, movies) as new technologies emerge (Herring, 2002). For example, doctors' exchange messages with individual or organizational sources of information, and according to the reciprocity of exchange, a doctors' acquisition of information may vary by two technical sub-categories. (1) Pull CMC consists of requests to experts (reciprocal exchange).when doctors' seek to answer a clinical question, and email a specialist (Bergus et al., 2000). (2) Push CMC does not satisfy momentary self-perceived information needs (non-reciprocal exchange), as doctors' receive a daily email synopsis of research in order to keep up-to-date.

Secondly, programmed decision-making is defined as specific procedures for solving problems (Simon, 1980), and is concerned with well-known situations, which may be represented by unambiguous algorithms and computerized into a DSS (Pluye & Grad, 2004). DSSs consist of decision rules and calculators, which match context-specific data with research and reference information to provide context-specific information. For example, clinical DSS require doctors to enter patient-related data in a computer (e.g. symptoms) to obtain disease risk estimates, probability of diagnosis and treatment recommendations (e.g. risk of developing coronary heart disease).

Thirdly, non-programmed decision-making involves general means (Simon, 1980), and is concerned with new or complex situations, whose translation into algorithms is too expansive or may be impossible (Pluye & Grad, 2004). IRT provides research and reference information potentially applicable to decisions about multiple contexts regardless of the presence of computerized context-specific data. This information may include images, sound and movies. For example, clinical IRT provides explicit medical knowledge about multiple patients regarding health education, disease prevention, diagnosis, therapy and prognosis (e.g. Medline—bibliographic database of the National Library of Medicine—and electronic textbooks).

These types of electronic information resources may be integrated within any platform (Internet, desktop, handheld computer or laptop). For example, electronic medical records may integrate Clinical CMC (e.g. e-prescribing), Clinical DSSs (e.g. dose calculator) and Clinical IRT (e.g. drug database), and doctors might combine these three types of resources to answer a clinical question. For example, a doctor may search IRT for diagnostic information on hemochromatosis. Subsequently, the doctor may search at home for curiosity, and find more relevant information within DSSs. Furthermore, the doctor may email a librarian or a specialist to learn more (CMC).

Impact is neither usefulness nor satisfaction. We define ‘impact’ as any immediate or future change, consequence, effect, influence, modification or outcome associated with information hits derived from any type of electronic information resource. Assessing the usefulness of electronic platforms and determining the relevance of the information they provide is still a difficult matter. One common approach to assessment consists of administering satisfaction questionnaires where users provide their subjective appreciation of the information presented. The analysis of the users answers to these questionnaires aims to characterize man-machine interactions, and ultimately to improve these interactions by implementing more efficient information retrieval means and information presentation means.

One skilled in the art can appreciate that evaluating the cognitive and behavioral impact of the use of an electronic information resource is not a trivial task. Little research has addressed this complex question, and no clear and recognized methodology to assess the impact of information exists. The inventors in the present application have evaluated the cognitive and behavioural impact of seven electronic information resources. In other work, the effect of clinical DSS on physician practice and patient care has been demonstrated using costly experimental methods (Garg et al., 2005) while observational studies suggest that about one-third of searches for information using clinical IRT may have an impact on doctors (Pluye et al. 2005). A study of the users' momentary assessment of the cognitive-behavioral impact of information hits, (Grad et al. 2005) found that DSS-calculated information and IRT-retrieved information may differ in terms of their cognitive-behavioral impact on doctors in everyday practice. In a cohort of 26 family medicine residents, DSSs were more frequently associated with reports of practice improvement, and IRT was more frequently associated with reports of learning and recall. Moreover, research on CMC “is still in its infancy” (Herring, 2002, p. 150).

However, negative impact may arise from irrelevant or invalid information or information overload, as information may paradoxically increase anxiety rather than reduce uncertainty (Case, 2002). For example, the notion of harmful information is generally acknowledged in health and medicine (Rigby et al. 2001). Even clinical practice guidelines may contain misleading information (Woolf et al. 1999) which computerization cannot prevent. Thus, the recognition of wrong or potentially harmful information is increasingly important as there has been substantial growth of information in all domains. In addition, there is no method to evaluate the quality of each information hit provided by electronic information resources. This is problematic both for users and decision makers, given limited budgets and the need to choose the most cost-effective resource.

### SUMMARY OF THE INVENTION

The present invention concerns information seeking behaviors using electronic information resources. The invention permits users to self-report in real-time an assessment of the cognitive-behavioral impact of the information provided by electronic information resources, whatever their type (e.g. CMC, DSS or IRT) or platform (e.g. desktop, internet, handheld computer or laptop). The present invention combines a computerized real-world momentary assessment method and a 5-level impact assessment scale. For the maintenance and comparison of resources, assessment of impact is complementary to existing relevance-based evaluation (e.g. user satisfaction).

A major shortcoming of the current information assessment paradigm described above is that it is mostly centered on man-machine interaction, while electronic platforms to access information resources are generally used to support the accomplishment of a specific task. The critical question that should be answered when trying to assess the impact of an electronic information resource should not be “how good was your interaction with the computer” but rather “how did the information provided by your computer help you to accomplish your task”. This paradigm shift has major implications, as we are not trying anymore to simply evaluate a system via subjective user feedback, rather we are trying to determine the cognitive and behavioral aspects of integrating electronic information resources in the daily practice of a professional whose primary objective is to accomplish a dedicated task as efficiently as possible.

The literature on organizations (administration and management), information studies and computer sciences was reviewed. There is no ordinal scale to systematically assess the impact of each information hit provided by electronic information resources. There is no interval scale outside laboratory settings (long questionnaires being inappropriate to gather real-world user evaluation) (Pluye et al. 2005). In evaluative research on the impact of retrieved information, users at best answer a discrete nominal question that can hardly be used to maintain resource validity and compare resources (e.g. does this information impact on your decision-making or action? Yes/No). Outside research settings, users at best answer questions on the relevance of information hits, (e.g. are you satisfied with this hit? Yes/No) which cannot be used to maintain resource validity and compare resources.

The relevance of information is not associated with its cognitive impact, as irrelevant information may impact on future decision-making or action. For example, a doctor searches for information on acute otitis media to answer a clinical question, and learns something new about mastoiditis, which is not relevant for the current patient, but may be important for future patient care. In addition, a relevant piece of information may have no impact. For example, the doctor retrieves information on acute otitis media, is pleased to find something, but disagrees with the content of this information hit, and so does not apply it. As there are no cognitive-behavioral impact assessment methods to collect real-world real-time user feed back, our solution opens up new possibilities for maintaining the validity of electronic information resources and for comparing their impact. In line with the “Acquisition-Cognition-Application” model proposed by Saracevic and Kantor (1997), (1) people retrieve information hits as related to intentions (acquisition), (2) they absorb, understand and integrate retrieved hits (cognition), and (3) they may use this newly understood and cognitively processed information for decision-making or action (application). Then, in line with Wilson (1999), the application of information might in turn influence future acquisition, and lead people to reiterate their search for information. This reiteration suggests a looping model as presented in FIG. 1. People “make use of the information found and may either fully or partially satisfy the perceived need—or, indeed, fail to satisfy the need and have to reiterate the search process” (p. 251). In line with this model, the present invention is described in FIG. 2.

Acquisition: In FIG. 2, the first row refers to five steps in the acquisition of information using electronic information resources. Step 1: The user starts a query by inputting commands, words or numbers into a search engine (IRT) or requests information via email (CMC). Step 2: The computer parses the database or sends the email. Parsing is the act whereby a document is scanned, and the information contained within the document is filtered into the context of elements in which the information is structured. Step 3: The user reads the list of information hits provided by DSSs, IRT or CMC, and selects one for review. Step 4: If DSS, the user must input further context-specific data (e.g. symptoms of a patient). Step 5: The output, namely one information hit, is displayed (e.g. a webpage).

Existing procedures (relevance): People may assess the situational relevance of each information hit (e.g. my clinical question is fully answered, partially answered or not answered by this hit), namely the value of an information hit for this person in a particular context at a certain point in time (FIG. 2, second row). The concept of relevance is fundamental to information-retrieval research and evaluation (Harter & Hert 1997 p. 18), and situational relevance remains subjective compared to topical relevance of a document that might be quantified as related to a query without human users (e.g. to measure the technical performance of meta-search engines) (Hersh, 2003).

Cognition: In FIG. 2, the third row refers to the contribution of our invention. When the output is displayed, it is cognitively processed by the user. Cognition is a mental process involving awareness with perception, reasoning and judgment. The output is linked to our impact assessment questionnaire to measure its cognitive-behavioural impact on the user at five-levels. In so doing, our method prompts the user in a systematic fashion to assess the perceived impact of information hits. Responses are added to a usage log file and automatically transferred to a server via the Internet. Because the user is prompted to answer the questionnaire for all hits, our computerized method also reminds users to complete questionnaires.

Invention (cognitive-behavioral impact): Retrieving information is generally useful, but may mislead (misinformation) and paradoxically increase uncertainty in decision-making (Case 2002). The inventors of this application have shown that medical doctors can systematically assess the positive and negative impact of information hits in comparison with their individual knowledge. The inventors have critically reviewed the world literature regarding the impact of Clinical IRT on medical trainees and doctors in practice, and found that information may affect, alter, change, confirm, improve, influence or help these professionals. Based on this review, we discovered a 5-level impact assessment scale, as the cognitive-behavioral impact of retrieved information on professionals may be strongly positive (1. change), moderately positive (2. reinforcement), neutral (3. no impact), moderately negative (4. dissatisfaction) or strongly negative (5. mistrust).

The content validity of our impact assessment questionnaire is high, and supported by three lines of evidence. 1: A case study of family doctors (Pluye and Grad 2004). 2: An extensive review of the literature (Pluye et al., 2005), and 3: A cognitive matching exercise conducted with information scientists, family doctors and researchers. The feasibility of our method is supported by empirical research, in which 26 doctors responded to 5,160 information hits over an eight month time period. Among 5,160 hits, 4,946 (95.9%) assessments were provided using our method. The ease of use of the method was further supported by individual interviews.

### BRIEF DESCRIPTION OF THE DRAWINGS

The invention will be better understood by way of the following description of the preferred embodiment with reference to the appended drawings, in which:

FIG. 1 illustrates a theoretical model of “Acquisition-Cognition-Application”;

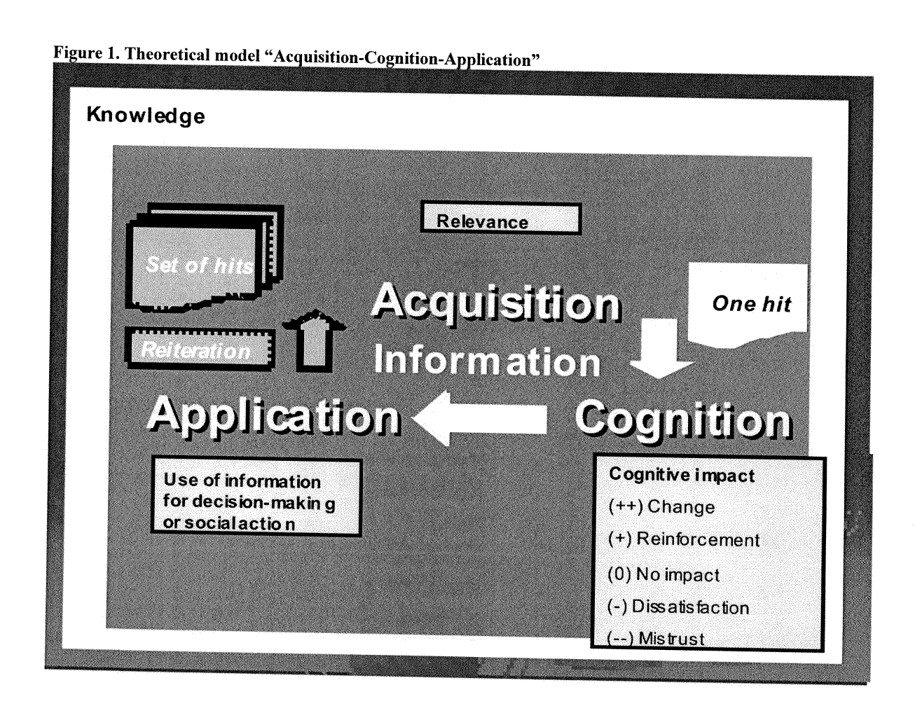

FIG. 2 is a flow chart of the process according to the preferred embodiment; and

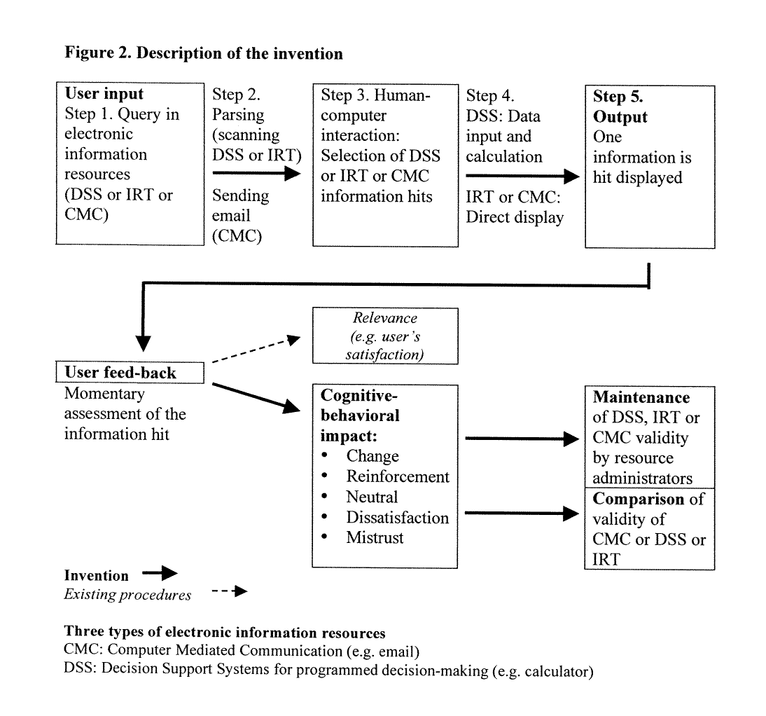

FIG. 3 illustrates a check-box form identifying cognitive-behavioral impact associated with information hits.

### DETAILED DESCRIPTION OF THE PREFERRED EMBODIMENT

According to the preferred embodiment, the users' momentary assessment of the cognitive-behavioral impact of information hits provided by electronic information resources will permit the maintenance of validity of all professional resources (e.g. clinical DSS and IRT), and their comparison. This is illustrated by the following two examples.

### Example 1

### Maintaining Resource Validity via Prompted and Systematic User Feedback (Cognitive-Behavioural Impact)

Problem: A doctor regularly reads an electronic newsletter to keep up to date. One day, s/he disagrees with the bottom line message of one information hit summarizing an important research study, because there appears to be a mismatch between the bottom line statement and the synopsis (summary or outline of the information hit). The bottom line states that: “After 2 years of treatment, chondroitin sulfate had no effect on comfort in patients with severe degenerative arthritis of the knee . . . ” The synopsis states that: “EPatients between the ages of 40 and 85 years were eligible to participate in this study unless they had severe changes on x-ray . . . ” Thus, information provided by the bottom line is not consistent with information found within the synopsis.

As a clinician, the doctor feels this new information is not applicable to practice, as s/he could not determine if severely affected patients were included or excluded in this research study. Thus, s/he does not understand how she could apply this new information in practice. Using existing procedures, the doctor could write to the president of the company in charge of providing this electronic newsletter. The president would respond after checking with the author of this information hit. Nevertheless, busy doctors do not usually take time for such correspondence.

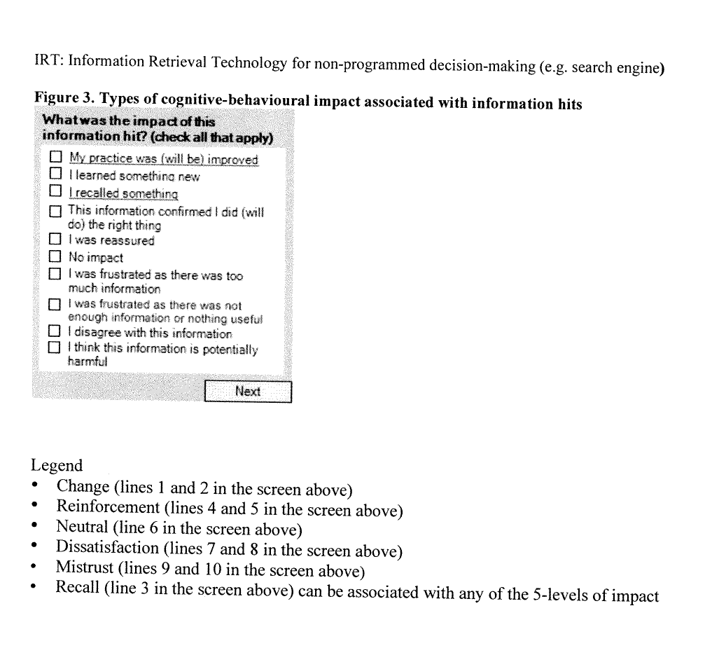

Solution using our invention: If the company had been using our cognitive-behavioral impact assessment method, they would have been automatically alerted to a problem with this particular information hit by one or many users. Consequence: Using our invention, the company would be more rapidly alerted to a potential problem with their information hits, and could then take the necessary steps to revise and correct their resource. In the specific example above, the company would have been alerted by reports of “I disagree with this information” (FIG. 3). The revised synopsis would clarify if severely affected were patients included in this research. A revised synopsis would read as follows “Patients between the ages of 40 and 85 years were eligible to participate in this study unless they had severe changes on x-ray and were scheduled for knee joint replacement. Patients included in the study were nevertheless severely affected with high pain scores and advanced joint disease on x-ray . . .
Other examples of the value of feedback linked to each impact type in FIG. 3:
[_] My practice was (will be) improved. An example of positive impact that can be used to enhance sales and marketing efforts, and for research on knowledge application.

For instance, a doctor reports that his practice was improved by knowing that triptans are effective treatment for a patient with acute migraine,
[_] I learned something new. An example of positive impact that can be used to enhance sales and marketing efforts, and for research on knowledge exchange and e-learning.
For instance, a doctor reports that she learned something new about Risperidone for treatment of delirium in the elderly with Parkinson's disease.
[_] This information confirmed I did (will do) the right thing. An example of positive impact that can be used to enhance sales and marketing efforts, and for research purposes.

For instance, after retrieving the Ottawa Knee Rules, a doctor confirmed that he did the right thing by ordering an X-ray.
[_] I was reassured. An example of positive impact that can be used to enhance sales and marketing efforts, and for research purposes.

For instance, a doctor reports that she was reassured by reading that Aspirin is effective for primary prevention of myocardial infarction.
[_] I recalled something. An example of positive impact that can be used to enhance sales and marketing efforts, and for research purposes.

For instance, a doctor read a specific information hit to recall normal values in order to interpret her patient's pulmonary function test.
[_] No impact. An example of the lack of impact that can be used to modify content, and thereby improve future communication.

For instance, a doctor read a brief report of a literature review on otitis media, and did not find any unexpected information.
[_] I was frustrated as there was too much information. An example of negative impact that can be used to modify content, and thereby improve future communication.

For instance, a doctor read a lengthy guideline on diabetes, and reported that there was too much information.
[_] I was frustrated as there was not enough information or nothing useful. An example of negative impact that can be used to modify content, and thereby improve future communication.

For instance, a doctor read a brief synopsis of clinical research that did not provide sufficient information about drug dose.
[_] I disagree with this information. See example one, and consider many situations in which busy editors may obtain user feedback regarding content that needs updating or alteration.

For instance, a doctor read a brief synopsis of clinical research that embellished the benefits of medication for insomnia.
[_] I think this information is potentially harmful. An example of negative impact, whereby busy editors may obtain user feedback regarding content that needs updating or alteration.

For instance, a doctor read a brief synopsis of clinical research that stated a medication he prescribes is not beneficial for prevention of cardiovascular disease.

### Example 2

### Comparison of Electronic Information Resources Using Prompted and Systematic User Feedback (Cognitive-Behavioural Impact)

Problem: In view of the development of primary care networks (e.g. Family Health Networks in Ontario), a provincial ministry of health wishes to provide electronic information resources to family doctors and other health professionals who join the network. Although the ministry obtains a number of opinions from respected clinicians, no clear consensus emerges as to which resources should be provided. For example, some clinicians believe that UPTODATE is more “effective” than other resources, such as CLINICAL EVIDENCE or INFORETRIEVER. Unfortunately, no simple evaluative method exists to compare resources in a systematic fashion, and as such, decision-makers cannot be provided with a valid answer to their question.

Solution using our invention: Our method of impact assessment could be used to compare electronic information resources in a systematic way using prompted feedback arising from real or simulated patient cases. For example, when companies (information providers) use our method of impact assessment, the analysis of impact data fed back to them by their users permits comparison of the frequency of positive impact (change, reinforcement) and negative impact (e.g. dissatisfaction, mistrust) across different resources.

Modifying content of an information resource using impact can involve one or more of the following: keeping or removal of information hits from the resource database or databases; and changing impact data providing the user with an indication of impact of the data for other users. It will be appreciated that gathering of impact data from users concerning a teaching or data record, determining impact, and then using the impact to filter or change the presentation of data is efficiently provided by the same system. However, the invention can be applied to circumstances in which the resource is separate and not integrated with impact assessment and filtering of resource results using impact. Furthermore, the information resource and system for impact assessment need not be entirely online or otherwise make use of computer data networks, as for example, answers regarding impact may be communicated by facsimile. In many cases, impact assessment should be done as soon as users begin having access to information hits so that the resource can be modified for the benefit of others. It will also be appreciated that modifying content of an information resource can be done efficiently in some circumstances in an automated way, while in others, the editor or author of the hits in the information resource will need to respond to impact to modify content. In some cases, the editor will need to consult with users to understand issues expressed in the impact assessment, so as to improve the content.

Consequence: The resources providing the most positive and least negative impact would be identified. The ministry would then know where to best invest their limited finances with regard to providing electronic information resources to health professionals.

### Example 3

### Application of the Method of Users' Momentary Assessment of Cognitive-Behavioral Impact of Information Hits in a Business Context

One skilled in the art can appreciate that the invention herein disclosed, though initially developed in the context of health care, has a much broader application scope. Imagine the following scenario: As a telephone call centre manager at an Internet Service Provider company (ISP), you oversee the delivery of technical and customer support to many clients. You have been mandated to improve the efficiency of service provided by ISP agents to clients who complain about long delays between the time they explain their problem to an agent and the time that the agent responds to the clients. The delay corresponds to the time agents spend searching the ISP internal Web-based repository of known problems and solutions (which is an example of IRT), for relevant information.

You rapidly realize that one solution to increase service efficiency is to reduce the average time spent by ISP agents to access the needed information. This reduction could be obtained by optimizing agents' queries to the repository. You decide to conduct a survey on the manner in which your agents interact with the repository, asking them to complete a four-page questionnaire on the tasks they accomplished in the last two weeks, such as: How satisfied are you with the interface to enter your query?, was this information relevant to your problem?, how difficult was it to find this information? etc. You obtain budget approval to pay your agents an extra hour to complete the questionnaire, and then ask your administrative assistant to compile the results and provide you with a summary report, confident that you will soon be in a position to make changes to the repository that will yield major productivity gains from all agents. Some agents respond quickly to the survey, some respond up to three weeks later.

While reading the report, you wonder if the information obtained will be useful. Some examples of the findings are as follows:
1. In the section on ‘How to query’ the repository, it is recommended that agents enter a description of the problem, followed by the version of the operating system used by the client. The survey reveals that 62% of ISP agents prefer to do the opposite.
2. A competitor is offering a subscription plan for $5.00 more per month than your company. An information bulletin is sent to all ISP agents to inform them of this competitive advantage. This information was rated as not relevant by 28% of agents, somewhat irrelevant by 8%, neutral by 24%, somewhat relevant by 22% and very relevant by 18% of the agents.
3. An “Introductory Plan” promotion advertised on TV required the subscriber to terminate a contract with your competitor. This fact was buried near the end of a three page document within the repository, and was rated by 64% of agents as ‘very difficult to access’.

Such findings are typical illustrations of the conclusions that can be obtained using available information assessment procedures. It can be very difficult to optimize electronic information resources, such as the ISP repository. The reasons for this difficulty are related to the advantages offered by the present invention, which permits automated momentary assessment of the impact of information hits within seconds, in the context of accomplishing a specific task. Had the present invention been used to perform such an assessment, feedback would have been obtained after the accomplishment of each task and findings could have rather been as follows:
1. Using our method, numerous agents report I disagree with this information linked to a specific hit: ‘How to query the repository’ (see FIG. 3). It turns out that agents want the operating system to default to Windows, as only a small minority need to solve LINUX-based problems. Thus, you learn it is preferable to enter information about the operating system only when a system other than Windows is used.
2. The information hit about a competitor plan was found to be “not relevant” or “somewhat irrelevant” by agents who assessed relevance from their technical perspective. Using our method, you would have discovered that even ISP agents that provide only technical support use this information hit when they are responding to difficult clients who complain about poor service offered by the company. These agents would report I learned something new (see FIG. 3) after reading the bulletin. Momentary assessment allows you to better identify reports of impact at the time the bulletin is actually sent out to ISP agents, and in relation to the specific task they are trying to accomplish in real time.
3. A significant number of agents were not able to accomplish their task, in so far as they could not find the information on plan eligibility as advertised on TV. Since your survey was conducted three months after the plan was phased out, it was rather late when you discovered that the needed information could not be found. Using our method, you would have received early reports in real time from agents who reported that I was frustrated as there was too much information (see FIG. 3). These reports would have alerted you to the need for early corrective action to revise the format of the information you need to deliver.

### Example 4

### Application of the Method to Fax Communication to Promote Knowledge Exchange

Problem: A pharmaceutical company currently sends information by fax to health professionals, for alerting and updating purposes as a result of changes in the product monograph of their drug. It is not known whether these fax communiques are indeed read by the intended recipient, and if so, what their impact is.

Solution using our invention: The director of medical communications at the company authorizes the addition of our impact assessment scale to future communiques. In so doing, the doctor can simply check the specific impact associated with that communique, and report back to the company by return fax.

Consequence: The company now has concrete evidence that the message was read and understood by the doctor. If the perceived cognitive impact is negative, corrective action can be taken to improve future communiques.

### Example 5

### Application of the Method to Facilitate e-Learning

Problem: Traditionally, physicians use continuing medical education to update their knowledge and increase their awareness of clinical practice guidelines. However, the effectiveness of traditional continuing education can be difficult to document, and physicians are increasingly interested in web based learning. As such, many companies now offer web based learning programs. Some of these programs deliver synopses of clinical research to physicians via email. These targeted email alerts may help the doctor to stay up-to-date, but how can companies and doctors demonstrate evidence of positive impact? Is it possible to automatically document impact, and thereby facilitate recognition by professional bodies of this activity, as e-learning?

Solution using our invention: Our impact assessment method, comprised of a simple questionnaire completed by health professionals in real-time, is systematically deployed on the user's computer screen as a pop-up linked to an e-learning event. The event is defined by evidence provided by our questionnaire, in so far as a doctor reports reflecting on an information hit, and that this reflection resulted in practice change or reinforcement of practice. Automatic accrual of continuing education credits is provided by the response to our impact assessment questionnire, linked to a specific information hit.

Consequence: Monitoring of e-learning and documentation of impact (e.g. changes in practice as a consequence of e-learning) are facilitated by our method.

### Example 6

### Application of the Method for Automatic Monitoring of Corporate Knowledge Management Systems

Problem: Under the direction of a chief knowledge officer, a consulting company (worldwide 40,000 employees) employs 400 full-time employees for knowledge management. They are responsible for documenting the existing knowledge and know-how in the company, making their information accessible in an electronic resource (knowledge management system). It is difficult to know the overall effect of information hits in the everyday experience of employees.

Solution using our invention: Our impact assessment method does not disrupt employees' workflow, and provides periodic summary data regarding the types of impact reported for each information hit (e.g. in the context of a weekly report). In so doing the chief knowledge officer can view this data, and monitor the impact of specific hits within the resource.

Consequence: The chief knowledge officer may report the evolution of the overall impact of the electronic resource (e.g. 90% of information hits are associated with a report of positive impact, and this frequency has been stable over the last year). He may undertake efforts to update information hits associated with reports of “no impact” or to correct hits associated with reports of negative impact (e.g. “potentially harmful”).

It will be appreciated that the invention applies to a variety of information resource systems, including those that provide news or information without a specific question basis but perhaps only a theme or subject, those that serve to provide answers to specific questions, as well as those designed to teach concepts in an organized manner for e-learning courses.

The following references cited above are hereby incorporated by reference:
Bergus G. R., Randall C. S., Sinift S. D. & Rosenthal D. M. (2000) Does the structure of clinical questions affect the outcome of curbside consultations with specialty colleagues? Archives of Family Medicine 9, 541-547.
Case D. O. (2002) Looking for information. Academic Press, London.
Garg A. X., Adhikari N. K. J., McDonald H., Rosas-Arellano M. P., Devereaux P. J., Beyene J., Sam J. & Haynes R. B. (2005) Effects of computerized clinical decision support systems on practitioner performance and patient outcomes: A systematic review. Journal of the American Medical Association 293, 1223-1238.
Grad R. M., Pluye P., Meng Y., Segal B. & Tamblyn R. (2005) Assessing the impact of Clinical Information-Retrieval Technology in a Family Practice Residency. Journal of Evaluation in Clinical Practice 11(6):576-86.
Harter S. P. & Hert C. A. (1997) Evaluation of information retrieval systems: Approaches, issues and methods. Annual Review of Information Science and Technology 32, 3-94.
Herring S. C. (2002) Computer-Mediated Communication on the Internet. Annual Review of Information Science and Technology 36, 109-168.
Hersh W. R. (2003) Information retrieval: A health and biomedical perspective. Springer, N.Y.
Pluye P. & Grad R. M. (2004) How information retrieval technology may impact on physician practice: An organizational case study in family medicine. Journal of Evaluation in Clinical Practice 10 (3), 413-430.
Pluye P., Grad R., Dunikowski L. & Stephenson R. (2005) Impact of Clinical Information-Retrieval Technology on physicians: A literature review of quantitative, qualitative and mixed methods studies. International Journal of Medical Informatics 74(9):745-768.
Rigby M., Forsstrom J., Roberts R. and Wyatt J. (2001) Verifying quality and safety in health informatics services. British Medical Journal 323, 552-556.
Saracevic T. & Kantor P. B. (1997) Studying the value of library and information services. Part I. Establishing a theoretical framework. Journal of the American Society for Information Science 48 (6), 527-542.
Simon H. A. (1980) Le nouveau management: la décision par les ordinateurs, Economica, Paris.
Taylor R. S. (1986) Value-added processes in information systems. Ablex Publishing Corporation, Norwood.
Thurlow C., Lengel L. & Tomic A. (2004). Computer mediated communication: Social interaction and the internet. Thousand Oaks: Sage.
Wilson T. D. (1999) Models in information behaviour research. Journal of Documentation 55 (3), 249-270.
Woolf S. H., Grol R., Hutchinson A., Eccles M. & Grimshaw J. M. (1999) Potential benefits, limitations, and harms of clinical guidelines. British Medical Journal 318, 527-530.

We claim:

1. In an electronic information resource delivering information, a method comprising:
delivering to said user said information from said information resource;
obtaining answers to questions concerning cognitive-behavioral impact of said information delivered from said user;
assessing cognitive-behavioral impact of said information delivered; and
responding to said impact of said information.

2. The method as claimed in claim 1, wherein said answers provide impact information related to a plurality of different constructs.

3. The method as claimed in claim 2, wherein said constructs comprise change, reinforcement, neutral, dissatisfaction and mistrust.

4. The method as claimed in claim 1, further comprising:
receiving a first request for said information from a user;
using contents of said electronic resource to retrieve said information in response to said first request, said information comprising a plurality of hits.

5. The method as claimed in claim 4, wherein said questions are delivered with each one of said hits reviewed by said user.

6. The method as claimed in claim 4, wherein said questions comprise items selectable as constructs comprise change, reinforcement, neutral, dissatisfaction and mistrust.

7. The method as claimed in claim 1, wherein said responding comprises modifying contents of said electronic resource in response to said assessed cognitive-behavioral impact of said information.

8. The method as claimed in claim 1, wherein said electronic information resource is a Decision Support System (DSS), an Information Retrieval Technology (IRT) or a Computer Mediated Communication (CMC), and said information is provided as a number of hits, said answers being obtained with respect to each one of said hits.

9. The method as claimed in claim 8, wherein said answers are obtained essentially immediately following initial review and study of said hits.

10. The method as claimed in claim 8, wherein said electronic information resource is a Clinical Information Decision Support System (CDSS), a Clinical Information Retrieval Technology (CIRT) or a Clinical Computer Mediated Communication (CCMC).

11. The method as claimed in claim 10, wherein said answers are obtained essentially immediately following initial review and study of said hits in a clinical context.

12. The method as claimed in claim 11, wherein said answers are obtained along a scale spanning change, reinforcement, neutral, dissatisfaction and mistrust.

13. The method as claimed in claim 11, wherein said user is provided with a computer for obtaining and displaying said information, and obtaining said answers.

14. The method as claimed in claim 13, wherein said computer provides access to said information, stores said answers and when connected to a data communications network communicates with a server of said electronic resource system.

15. The method as claimed in claim 1, wherein said delivering comprises a broadcast of a message containing said information and said questions to a number of said users.

16. The method as claimed in claim 15, wherein said broadcast comprises facsimile transmission, and said obtaining answers comprises receiving return facsimile transmissions from said users of at least one page of said message with said answers marked thereon.

17. In an electronic information resource delivering information in response to requests, a method comprising:
assessing cognitive-behavioral impact of information delivered; and
modifying contents of said electronic resource in response to said assessed cognitive-behavioral impact of said information.

18. The method as claimed in claim 17, wherein said impact is defined along a scale spanning change, reinforcement, neutral, dissatisfaction and mistrust.

19. An electronic information resource system delivering information in response to requests, the system comprising:
a first server for receiving a first request for information from a user and for using contents of an electronic resource database to retrieve information in response to said first request, and delivering to said user said information including questions concerning cognitive-behavioral impact of said information delivered; and
a second server obtaining answers to said questions from said user and assessing cognitive-behavioral impact of said information delivered.

20. The system as claimed in claim 19, wherein first server and said second server are integrated with said electronic resource database.

21. The system as claimed in claim 20, wherein said second server automatically modifies contents of said electronic resource in response to said assessed cognitive-behavioral impact of said information.
